(19) United States
(12) Patent Application Publication
(10) Pub. No.: US 2007/0205541 A1
(43) Pub. Date: Sep. 6, 2007

(54) Buck shot blues specially processed denim product and the process methods to make the product

(76) Inventors: Dann Allen, Hartford City, IN (US); Yolanda Brown, Hartford City, IN (US)

Correspondence Address: RITCHISON LAW OFFICES, PC;John D. Ritchison, Suite A, 115 East Ninth Street, Anderson, IN, 46016-1509, US

(21) Appl. No.: 11/713,333

(22) Filed: Mar. 2, 2007

Related U.S. Application Data
(60) Provisional application No. 60/778,702, filed on Mar. 3, 2006.

(51) Int. Cl. B29C 43/22

(52) U.S. Cl. 264/555

(57) ABSTRACT

A process and the resulting uniquely configured product called “Buck Shot Blues”. The base product is a fabric such as denim that has been processed and altered to accomplish an appearance that the fabric has been “blasted” by buck shot or small metal pellets. The resultant fabric has a plurality of holes or apertures in a “blast pattern” that is either specific or random. The holes or apertures after processing are “frayed” from the penetration of the blast elements. The manner of production includes a number of methods, from a simple blast scheme to more complex production processes. An alternative computer controlled manufacturing process is also provided where the individual interacts with the process that produces his garment.

### CROSS-REFERENCE TO RELATED APPLICATIONS

This application claims the benefit of Provisional Patent Application Ser. No. 60/778,702 filed Mar. 3, 2006 by Dann Allen and Yolanda Brown, and titled “Buck Shot Blues, a Specially Processed Denim Product and the Process Methods to Make the Product”.

### FIELD OF INVENTION

This invention relates to special denim “Buck Shot Blues” fabric that has been processed and altered in a special way and the examples of methods to accomplish the special appearance that the fabric has been “blasted” by some form of buck shot. Particularly this denim product is related to a special alteration to a denim garment that provides a special look and configuration to the fabric. Equally important are the processes or methods to accomplish the production of the altered “Buck Shot Blues” fabric.

The resultant fabric has a plurality of holes or apertures in a “blast pattern” that results in holes or apertures that are frayed along the edges of the fabric. The resultant may be a pattern of frayed elements or a random effect. The invention includes a number of methods or processes to accomplish production of this “Buck Shot Blues” special fabric and method. This configuration may be processed in a number of ways—from a simple blast scheme of a shotgun or equal to manufacture a low quantity of “blasted denim” to a more complex production process with equipment and machinery to manufacture the product at a significantly higher volume. Whether simple or complex, the effect of the mechanism propels the shot pellets through the fabric to provide the frayed results.

### FEDERALLY SPONSORED RESEARCH

Not Applicable.

### SEQUENCE LISTING OR PROGRAM

Not Applicable.

### BACKGROUND—FIELD OF INVENTION

The new Buck Shot Blues Specially Processed Denim Product and the Process Methods to Make the Product described in this specification is a product and process that are designed to easily and quickly provide a new and unique fabric surface for various materials and fabrics. The product and process are especially successful with denim fabrics to produce the unusual fabric configuration through the processes described below.

A. Introduction of the Problems Addressed

Fashion and modern trends over the years have reached out for new fabrics and conditions of the fabrics. The trends have produced the likes of “tie-dyed” cloths, “ripped or tattered” jeans, patched, stone washed, sequined, and other types of fabric “conditioning”. Over the years even some of the “destructive” looks have provided fashion hits with the unique and useful fabrics. Often, these new looks have required difficult, time consuming and costly processes to provide the fabrics. Often these processes required multiple steps and process “wait” times to create the fabric effects desired. Likewise, the resultant fabric may be only used for limited types of garments.

B. Prior Art

Historically, fabric conditioning has been accomplished in washing machines or on assembly processes as the full fabric bolts and not finished garments. Several devices have attempted to provide unusual fabrics, but have not produced the unique results provided by the Buck Shot Blues Denim Product and the Process Methods to Make the Product. In use, the prior art devices and processes were often complex, difficult to install, expensive to operate, and limited in use. The new Buck Shot Blues Denim Product and the Process Methods to Make the Product address these limitations and provides a solution to the stated problems.

Examples of prior fabric processing methods and equipment begin with U.S. Pat. No. 16,190 issued to I.S. Roland (1856). This teaches a washing machine with an enclosed box and engagement mechanism that turned and agitated wooden balls included in the box with the fabric pieces in a liquid solution to process and wash the materials. The device has simplicity but offers no permanent surface configuration or “fraying” as the current Buck Shot process. The resultant materials and fabrics have no permanent alteration claimed. Another improvement for a material and fabric process was issued to Raymond F. Heyer as U.S. Pat. No. 4,486,200 (1984). It teaches an abrasive article comprising a plurality of separated abrasive agglomerates distributed within a matrix of undulated filaments. The invention provides a method of making an abrasive article comprising forming, within a lofty open web; comprising undulated filaments bonded at points of mutual contact; and comprising a plurality of separated abrasive agglomerates to provide an abrasive agglomerate-impregnated web. Articles may be prepared by the process by laminating layers of the web together, preferably under pressure. Common articles produced by this process include abrasive wheels, discs, belts, sheets, blocks and the like. It is not taught for fabrics or garment conditioning. This is unlike the Buck shot product and process in that extent that a very complex system is required to provide the resultant materials. Pressure is not taught at all as a necessary or optional requirement in the Buck shot innovation.

Other examples of processes for fabrics include a U.S. Pat. No. 4,575,887 issued to Julio C. Viramontes (1986) which teaches a method for abrading fabric garments. The method is for abrading fabric garments in a washing machine. The garments are placed in the washing compartment of a washing machine and the machine is filled with sufficient hot water to cover the garments. The garments are then thoroughly soaked, and after the soaking, then the compartment is drained of sufficient water to enable the compartment to accept a predetermined amount of small sized abrasive particles to uniformly abrade the garments. The abrasive particles are added to the compartment and agitated until the garments are uniformly abraded. Next the compartment is drained of substantially all of the water and abrasive; rinsing and re-draining are accomplished, and the sand removed from the filter for reuse in subsequent abrading operations. The process uses a wet, washing method unlike the “dry” system taught by the Buck Shot Blues Process and Methods to Make the Product. A U.S. Pat. No. 4,765,100 issued to Curtis O. Majors (1988) teaches a method of abrading new garments. The method of “stone washing” jeans is disclosed. The process involves tumbling jeans without water and in the presence of resin-bonded abrasive members in a first elongated tumbler drum, discharging the jeans and abrasive members from the first tumbler drum, separating the abrasive members utilizing an oscillating conveyor, feeding the jeans to a second elongated tumbler drum having a perforated wall to remove any remaining abrasive members from the jeans and thereafter removing the treated jeans from the second tumbler drum while recycling the abrasive members to the first tumbler. This process is a dry process that produces “worn-looking” and white streaked fabric. The new Buck shot process is a dry system that can be used producing “new” fabric or worn fabric with the “frayed” shot effects. The resultant may be a pattern of frayed elements or a totally random effect of frayed elements.

An abrasive method for processing was shown in U.S. Pat. No. 4,750,227 issued to Gregory J. Hopkins that taught abrasive structures and methods for abrading fabrics. An abrasive structure for stone washing garments in a wash medium and a method for abrading garments using that abrasive structure was used to achieve controlled abrasion of those garments. The abrasive structure has a uniform abrasive surface—which will not damage or excessively wear fabrics and garments being subjected to the stone washing method; which will not deteriorate during use; and which will provide uniformly stone washed garments having a consistent nap and a low level amount of textile wear. The abrasive structure is formed of a substantially form-retaining material having a resilient abrasive surface. The system is wet and complex as opposed to the new innovation shown here for Buck Shot Blues Denim Product and the Process Methods to Make the Product. Another wash process is taught in U.S. Pat. No. 4,845,790 issued to Mitchell R. Brasington (1989) that teaches a method and apparatus for altering fabric finishes. The invention shows improved methods and apparatus that are provided for altering fabric finishes on a garment to give the garment a “lived-in” or worn appearance before the garment is actually worn by the user. According to the method of the present invention, a batch of garments is preferably stone-washed to generally fade and abrade the entire garment. The garment is then inflated by passing air through an inlet port in the garment and by substantially sealing one or more exit ports in the garment to create a greater than atmospheric pressure within the garment. The inflated garment is then sprayed with a low-strength bleaching solution on selected exterior portions to provide an additional fading or worn appearance on those portions of the garment. Thereafter, the garment is placed in a neutralizing liquid to chemically counteract the sprayed bleaching solution. A plurality of garments may be each suspended from a common air duct interconnected with a blower for providing air to inflate the garments. The Buckshot product and process involves simple process steps, no chemicals, no wet and dry requirements, and simple devices to process the fabric surface. The innovation is less expensive and provides a random, unique conditioning of the fabric with “frayed” effects to the fabric and garment surfaces.

A rigorous and complex tufting machine is shown and taught by the U.S. Pat. No. 5,526,760 issued to Thoi Ok (1996). The tufting innovation provides machine having a needle bar movable between at least two transverse locations in response to a control signal, a motor, a yarn supply, a backing cloth feed, a stitch drive, looper drive, yarn feed roller and all parts being timed for moving the respective components at times in the stitch cycle when the needles are clear of the backing. The tufting machine operates to produce a series of stitches through the backing material by moving the needle bar to cause the needles to pierce the backing cloth and interact with the looper mechanism to produce a tufted fabric. The new Buckshot product is more random in comparison and far less complex as an enabling process. The fabric produced has “random or patterned frays or tufts”. A U.S. Pat. No. 5,647,937 issued toe Anton Ronai (1997) was focused at textile manufacturing apparatus for another fabric configuration. It teaches a textile manufacturing apparatus to be used to manufacture a sequined textured fabric. The apparatus includes a first and a second material film, portions of the second material film protruding through the first material films. The manufacturing apparatus is structured to cut an array of geometric shapes into a dual layer sheet formed by the first and second material films. The geometric shaped cutouts define a plurality of geometrically shaped members and a plurality of geometrically shaped apertures. Further, the manufacturing apparatus is structured to push the geometrically shaped members into a raised orientation above an upper surface of the dual layer sheet resulting in the geometrically shaped members of the second material film protruding through the geometrically shaped apertures of the first material film. The apparatus is further structured to stagger the first material film relative to the second material film so as to space the members of each material film in order to form the sequined, textured fabric. A backing material layer is finally added to secure the first and second material films in their staggered orientation. The step ensures that the overall appearance of the fabric is maintained and that the fabric will not easily tear or unravel during use. The teaching is highly complex, expensive, and provides a completely different result than the Buck shot innovation. Finally, a fabric making process is taught in U.S. Pat. No. 6,663,823 issued to Toshio Kobayashi (2003). This shows a process and apparatus that is used for making non-woven fabric. The process teaches a system in which continuous fibers are evenly distributed and neither bundles nor lumps of the fibers and includes a guide box for continuous fibers being provided between extruding nozzles adapted to discharge the continuous fibers under hot air blast and a conveyor belt. The guide box has an upper end opening and a lower end opening being larger than the upper end opening. The continuous fibers are subjected to a suction effect provided from below the guide box so that the continuous fibers may be secondarily stretched and thereby thinned within the guide box. The Buck shot process is extremely simple in comparison without the need for complex process and controls to provide the desired product. The resultant fabric condition of frayed surfaces is significantly different.

As far as known, there are no specially altered denim products with a blast pattern from buck shot or the like. Equally significant is that there are no known processes or methods taught with a combination of process steps that accomplishes the same or similar production processes taught in this invention. It is believed that this product is unique in its design and that the processes to accomplish both low and high volume productions are equally improved and optimized, if not a unique, as a combination of process equipment and technologies.

### SUMMARY OF THE INVENTION

This invention is a special denim “Buck Shot Blues” fabric that has been processed and altered in a very special way. Taught here are the special frayed fabrics which result from the process and the alternative methods used which accomplishes the appearance that the fabric has been “blasted” by buck shot. This special alteration to the denim garment provides a new, different, and special look and configuration to the fabric. The resultant fabric has a plurality of holes or apertures in a “blast pattern” either specific or random. The holes or apertures after processing are “frayed” from the penetration of the blast elements. The manner of production includes the method or process to accomplish this buck shot blues fabric and clothing in a number of ways—from a simple blast scheme to a more complex production process. An alternative computer controlled manufacturing process is also described which permits one to “choose the garment” and pattern even from the internet.

The preferred embodiment of the fabric device is comprised of the processed fabric itself. This may be for example, and not as a limitation, denim (preferred), cotton, hemp, rayon, nylon or other fabrics, including synthetic composite materials. The fabric is exposed to a process of several steps described below. The basic process is to impinge or blast media onto and through the fabric. One simple example of this is to “shoot” or “blast” the fabric or product with a shotgun. Several alternative processes are also described below that will “mimic” a shotgun blast.

The newly invented “Buck Shot Blues” special fabric and method may be produced at low volumes by very simple means and in high volume production by more complex and controlled systems.

### OBJECTS AND ADVANTAGES

There are several objects and advantages of the “Buck Shot Blues” special fabric and method. There are currently no known resultant fabrics or processes to produce such fabric and products that are effective at providing the objects of this invention.

One advantage and object of the present invention is that it is a new and unique fabric alteration. This blasting results in leaving small, frayed apertures or holes which provides a way to enhance denim and other fabrics with a design that is unique. Individualism may be further demonstrated by creating different designs on differing garments and fabrics.

Another object for the “Buck Shot Blues” special fabric and method is that it is providing a modern fashion statement of the times—capable of embracing both conservative and liberal statements by the way people dress and the garments and products they choose to wear or use.

There is another object of the present invention which is to have a low manufacturing costs. This is accomplished by using simple shotgun or barbed roller devices for low volume production and more complex and automated equipment for higher volumes.

A further advantaged offered with the “Buck Shot Blues” special fabric and method is that it is designed for versatility. By using various process means, different garments and products may receive the treatment.

A further advantage is in the product distribution. The “Buck Shot Blues” special fabric may be marketed and sold in retail stores where denim products are currently sold or on the internet one unique product at a time.

Finally, other advantages and additional features of the present “Buck Shot Blues” special fabric and method will be more apparent from the accompanying drawings and from the full description of the device. For one skilled in the art of fabric alteration and treatments and the processes to produce such fabrics, it is readily understood that the features shown in the examples with this product and process are readily adapted to other types of fabric preparations and fabrications.

### DESCRIPTION OF THE DRAWINGS—FIGURES

The accompanying drawings, which are incorporated in and constitute a part of this specification, illustrate an embodiment of the “Buck Shot Blues” special fabric and processing method that is preferred. The drawings together with the summary description given description given below serve to explain the principles of the “Buck Shot Blues” special fabric and method. It is understood, however, that the “Buck Shot Blues” special fabric and method is not limited to only the precise arrangements and instrumentalities shown.

FIGS. 1A and B are photographs of a general fabric 31 that has the special fabric treatment referred to as “Buck Shot Blues”.

FIG. 2A and 2B are photographs of additional products of “Buck Shot Blues” with some of the features noted.

FIG. 3A and 3B are drawings of some Trademarks for the “Buck Shot Blues” special fabrics.

FIG. 4 is a sketch showing a simple process to produce the “Buck Shot Blues” special fabrics and products with a shotgun blast or the like.

FIGS. 5A and B are sketches of a computer controlled process for manufacturing unique “Buck Shot Blues” special fabrics and products in a controlled yet flexible manner.

FIG. 6 is a drawing of a high volume shot blast process to produce a high volume of the “Buck Shot Blues” special fabrics.

FIGS. 7A and 7B are sketches of alternative processes that utilize barbed spikes on rollers to mimic a blast and produce low and high volumes of “Buck Shot Blues” special fabrics and products.

FIGS. 8A and 8B are charts showing typical blast velocities and pellet details.

FIG. 9 is a process flow chart providing the basic and simple steps of the process to produce “Buck Shot Blues” special fabrics and products.

### DESCRIPTION OF THE DRAWINGS—REFERENCE NUMERALS

The following list refers to the drawings:
30 “Buck Shot Blues” special fabric and method
31 general denim garment with frayed holes
31 A rear side of general denim garment, here shorts
31B general denim garment, here a jacket
31C general denim garment, here pants
31D general garment, here shirts
32 resultant buck shot apertures or holes frayed at the edges of the opening
33 close-up section of denim where the hardware is attached
34 hardware (buttons, snaps, or the like)
35 Trademark sign drawing
36 Trademark “Buck Shot Blues” photo of sign
37 simple shotgun
38 means to support system structure
39 means to support garment or product
40 safety back-stop wall
41 blast or pellet pattern
42 means to transfer garment or product
43 multiple blast nozzles
44 computer control system
45 shot blast chamber machine
45A shot blast chamber (single or multiple nozzles)
46 single barbed roller device
47 handle
48 barbed spikes
49 roller section
50 fabric process machine
51 virgin fabric
52 processed fabric
53 velocity chart
54 pellet chart
55 pellet
56 chart of typical process steps
57 operator (shooter of shotgun)
58 supports to rollers supporting fabric
59 machine table/bed
D variable distance from gun to garment

### DETAILED DESCRIPTION OF PREFERRED EMBODIMENT

The present development is a product and process for a person to treat fabrics and products in a new and special manner called a “Buck Shot Blues” special fabric and method 30. Particularly this product is related to a special alteration to a denim garment that provides a special look and configuration to the fabric. Equally important are the processes or methods to accomplish the production of the altered “Buck Shot Blues” fabric.

The resultant fabric 31 has a plurality of holes or apertures 32 in a “blast pattern” that results in holes or apertures that are frayed along the edges of the fabric. The invention includes a number of methods or processes to accomplish production of this “Buck Shot Blues” fabric and products. The method to process this “Buck Shot” configuration is accomplished in a number of ways—from a simple blast scheme of a shotgun or equal 37; to the manufacture a low quantity of “blasted denim” 46; to a more complex, higher volume production process with equipment to manufacture a significant volume of product 45 and 50; and, to a computer controlled device 44 to provide high versatility. The process devices may have an alternative embodiment with various materials and designs.

The improvement over the existing art is providing a device that:

a. is a new and unique fabric alteration;

b. provides a modern statement of the times;

c. has a low manufacturing costs;

d. is designed for versatility; and

e. has a developed product distribution system.

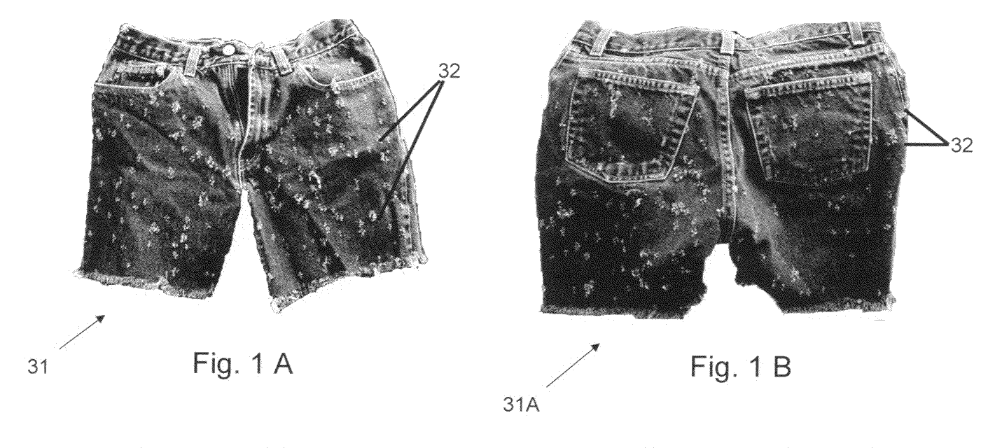

There is shown in FIGS. 1-9 a complete description and operative embodiment of the “Buck Shot Blues” special fabric and method 30. In the drawings and illustrations, one notes well that the FIGS. 1-9 demonstrate the general configuration and use of this product and process development. The preferred embodiment of the product 31A is comprised of fabric (denim or other) that has the alteration from blasting resulting in the frayed apertures 32 (in a defined area that is either in a perceivable pattern or a completely random configuration with no discernable pattern). The various example processes to accomplish the alteration are described.

The accompanying drawings, which are incorporated in and constitute a part of this specification, illustrate an embodiment of the “Buck Shot Blues” special fabric and method 30 that is preferred. The drawings together with the summary description given above and a detailed description given below serve to explain the principles of the “Buck Shot Blues” special fabric and method 30. It is understood, however, that the “Buck Shot Blues” special fabric and method 30 is not limited to only the precise arrangements and instrumentalities shown. Other examples of altered fabrics with resultant frayed apertures 32 and other processes to create the frayed apertures are still understood by one skilled in the art of fabric alterations to be within the scope and spirit shown here.

FIGS. 1A and B are Photographs of a general fabric 31 that has the special fabric treatment referred to as “Buck Shot Blues”. FIG. 1A is a photograph of the front view of a pair of treated denim shorts 31. In FIG. 1B, the shorts are photographed from a rear view 31A. In both views the fabric shows the frayed apertures 32 caused by the “blasting” process described in this specification. While denim is the preferred fabric, other fabrics may benefit from the “Buck Shot Blues” method 30. These other fabrics for example are cotton, hemp, rayon, nylon or other fabrics, including synthetic composite materials.

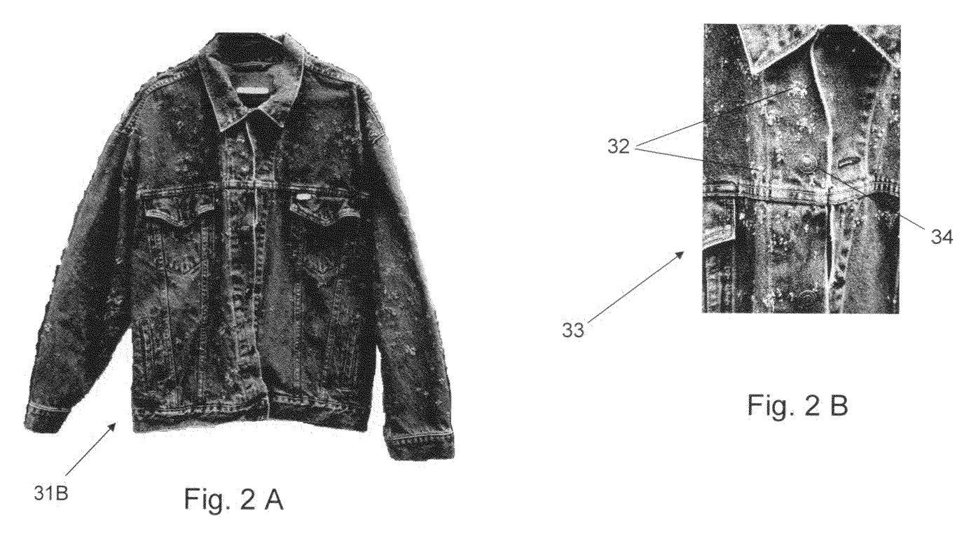

In FIG. 2A is a photographs of additional products of “Buck Shot Blues” with some of the features noted. Here a denim jacket 31B is shown. The use of various fabrics and products are anticipated by the “Buck Shot Blues” special fabric and method 30. As examples and not as limitations a listing of such products and clothing are shown in Table A.

TABLE A
Examples of Specially prepared Products and Clothing

| | |
|---|---|
| Clothing | |
| Denim wear (all types) | Overalls |
| Coats | Pants |
| Jackets | Capes |
| Coveralls | Blouses |
| Jeans | Skirts |
| Shirts | Dresses |
| Ponchos | Pedal pushers |
| Pullovers | Infant wear |
| Vests | Beachwear |
| Waistcoats. | |
| Products | |
| Denim accessories (purses, | Automotive seat covers |
| handbags, bandanas, shawls, | |
| etc.) | |
| Curtains | Slippers and shoes |
| Luggage | Kitchen fabrics |
| Slip Coves | Bedspreads |
| Couch covers | Afgans |
| Bolts of Fabric | Yard Goods |

Importantly in FIG. 2B, the view of the jacket front 33 shows the hardware 34. As part of the processing of the fabric or products through the “blasting” process, devices such as zipper protectors, button covers, and other various materials may be used to protect hardware on product from damage. Other devices are also used to block the design from appearing on the areas of fabric that is to stay free of the design blast pattern. Or, from another process design direction, the blast system may be made to permit the pellets to impinge only on certain areas of fabric so the projectiles can go through only those unprotected areas of the pattern.

In Table B describes several examples of enhancements to the product by modifying parts of the process.

TABLE B
Alternative Enhancements to Process and Product

| What | Effect |
|---|---|
| Bleach substance on shot | Whitens fray effect |
| Colored dyes & other chemicals | Colors Fray pattern |
| on shot | |
| Type of Beads - lead, metal, | Varies the fraying pattern |
| glass, seeds, plastic, | |
| composite, etc. | |
| Multiple passes through blast | Varies pattern and density |
| and distance from gun to garment | of fray effect |
| Devices such as zipper | Protect hardware on |
| protectors, button covers, and | product from damage. |
| other various materials | |
| Block shield on material | Protects material areas to |
| | remain pattern-free |
| Multiple patterns | Provides different size |
| | design choice of location |
| | of effect per product. |
| | Design may include from |
| | one to a limitless number |
| | of effects per product. |
| Placement of Patterns | Patterns may be placed on |
| | product with precision or |
| | as a random effect. |
| Combination of Patterns | Some larger effects may be |
| | created by combining a |
| | series of smaller effects. |

From this Table B, one skilled in the art of fabric alteration realizes the process can vary the results in many ways. Alterations to the fabric may be made one at a time or multiples at a time. Multiple garments may be altered at the same time with one blast or with other means such as stamps, presses, rollers or other machinery and/or objects to mimic the design. The perforation design in fabric may be accomplished either by projectiles or pellets 55 impinging onto and through the fabric (such as a shot gun blast 41 or shot blast 45) or by any other means to mimic effect (such as by a hand roller 46 or fabric conveyor 50). The use of color to enhance the effect of the design may be added to the projectile to imprint color. Coloration of the design/designs can also be done after the “Buck Shot Blues” pattern is in the fabric. When using shot blast systems 41, 45, the pellets 55 shot may contain many types of projectiles 55 such as standard lead, steel shot, glass, plastics, composites, organic matter like shells of nuts or anything equal feel that will make the design. Likewise, when using blast method projectiles may be powered by many different means.

Many of the blasting techniques and details are described in Table C.

TABLE C
DETAILS ON BLAST PROCESS

| Item | Description |
|---|---|
| A | Projectiles are loaded into a tube/s and is backed with a |
| | propellant. For an example: A 12 gage shotgun loaded with |
| | standard metal shot and is shot at the, say blue jeans, at a |
| | given distance the propellant is gun powder. The pellets hit the |
| | fabric/material and penetrate through causing a tare/hole in the |
| | fabric/material. One to infinite number of pellets can be |
| | blasted into/through the fabric/material. The pattern/patterns |
| | in the fabric/material can be differed by blasting farther or |
| | closer to the fabric/material or impenetrable patterns can be |
| | placed over the fabric/material to create designs within the |
| | design/designs. |
| B | Standard 12gage buckshot pellet sizes range from 9.14 mm to as |
| | little as 2.03 mm and can fire one to multiple numbers of metal |
| | projectiles. The muzzle velocity will very but a good guess is |
| | around 1500 feet per second fps ample energy to penetrate into or |
| | through the fabric/material. The velocity impinging the garment |
| | varies also with distance from the barrel to the garment. |
| C | Air rifles can also create the pattern/patterns using compressed |
| | air or other gasses. Muzzle velocity will very with the |
| | pressures used as a propellant. |
| D | Not all projectiles used may be intended to penetrate the |
| | fabric/material. Some projectiles may be used just to carry |
| | color/colors and/or chemicals only onto the fabric/material. |
| | Although some projectiles that do penetrate may also carry |
| | color/colors and/or chemicals onto and into the fabric/material. |
| E | Many objects may be used as projectiles. Some previously |
| | mentioned such as metal balls of all shape and sizes, glass all |
| | shape and sizes, plastics all shape and sizes, metals all shape |
| | and sizes, (liquid containers of all shape and sizes to carry |
| | chemicals such as dyes, bleaches, oils, various chemicals, and |
| | paints just to name a few.) Not all projectile have to be man |
| | made for example various size rocks. So many objects can be used |
| | as projectiles that it would be impossible to name them all. |
| F | Some projectiles may be used to impregnate into the |
| | fabric/material. |
| G | The Blasting Method may use a shotgun handheld, machinery |
| | completely automated, a handheld mechanical device that |
| | punctures holes one at a time or multiples at a time. Some |
| | machines could be operated from a remote place using |
| | computers via internet or other means to run the machine. |
| H | A piece of material or coated material may be placed on or in |
| | front of the product to shoot through to pick up dies, paints, |
| | chemicals, or other materials and so on. |

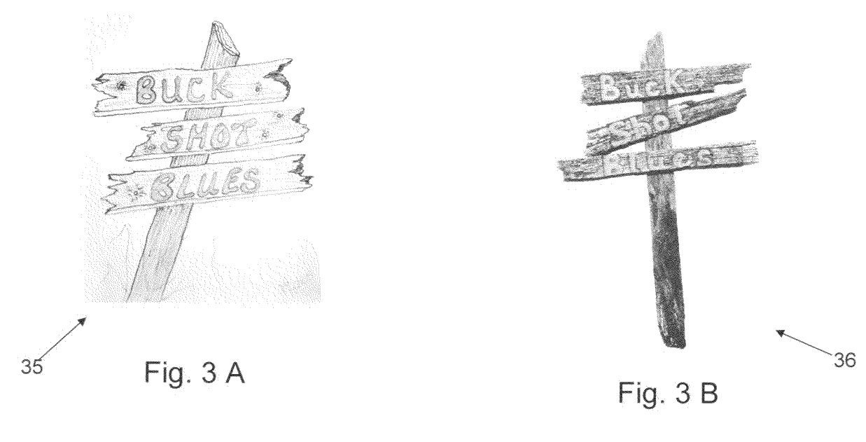

FIGS. 3A and 3B are drawings of the Trademarks for the “Buck Shot Blues” special fabrics. The sign drawing 35 and the drawing of a photo of the sign 36 with the words “Buck Shot Blues” is used to denote and mark the special fabric 30 in the various forms (31, 31A, 31B, 31C, and 31D or the like—See Table A).

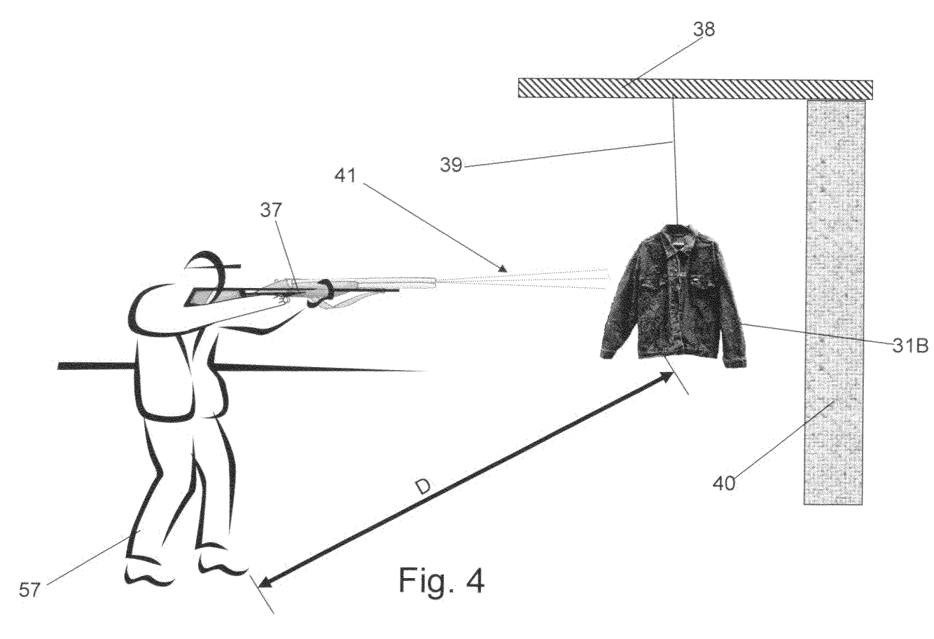

FIG. 4 is a sketch showing a simple process to produce the “Buck Shot Blues” special fabrics and products with a shotgun blast 41 or the like. Here a garment 31B is held by some hanging means 39, preferably in front of a safety back-stop wall 40. The means 39 is supported by some rigid and durable structure 38 to carry such hanging means 39. An operator 57 holds the shotgun 37. The operator “aims” the shotgun 37 and fires the blast 47 into the garment 31B. One skilled in the art appreciates that a mechanical device rather than a human operator 57 might well be used to steady the shotgun 37. Equally understood is that the shotgun 37 might be triggered and “fired” into the garment 31B from a remote location by means of a physical connection (such as a wire or mechanical linkage) or by a wireless device. Finally, distance D from gun to garment may vary which changes pattern and velocity of impingement.

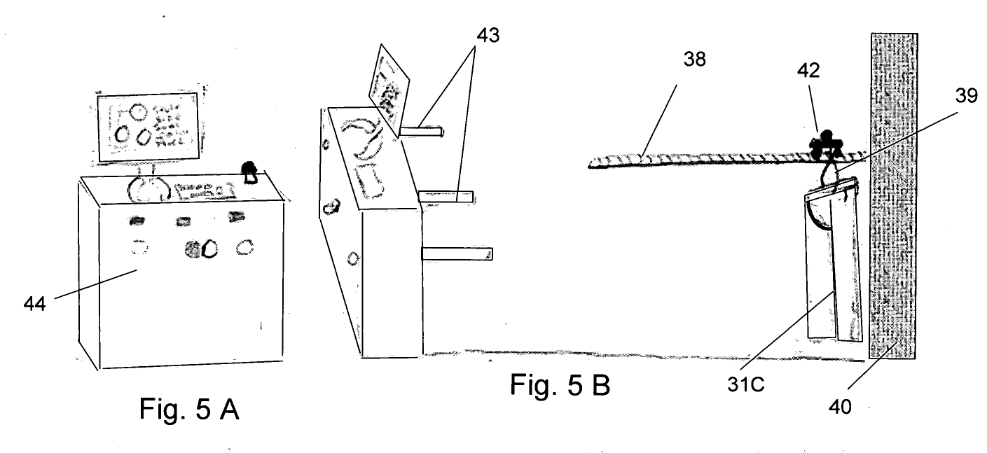

FIGS. 5A and B are sketches of a computer controlled process for manufacturing unique “Buck Shot Blues” special fabrics 30 and products in a controlled yet flexible manner. Here the control means 44 operates the multiple blast nozzles 43 as shown in a Front View FIG. 5A. In the Side View of the computer controlled unit, the computer control 44 permits the multiple blast nozzles 43 to “fire and shoot” the garment 31C, here a pair of jean pants. The garment 31C is on a hanger 39 which is connected to a transfer means 42. The transfer means 42 is supported by a structure 38. When the blasting of the garment 31C is completed, the transfer means 42 is signaled by the computer control 44 and the pants 31C are transferred to the front, out of the nozzles 43 pathway for a safe and secure removal from the hanger means 39. One skilled in safety appreciates the need for a safety wall 40 around part or all of the mechanism to provide a secure and safe environment for the operation.

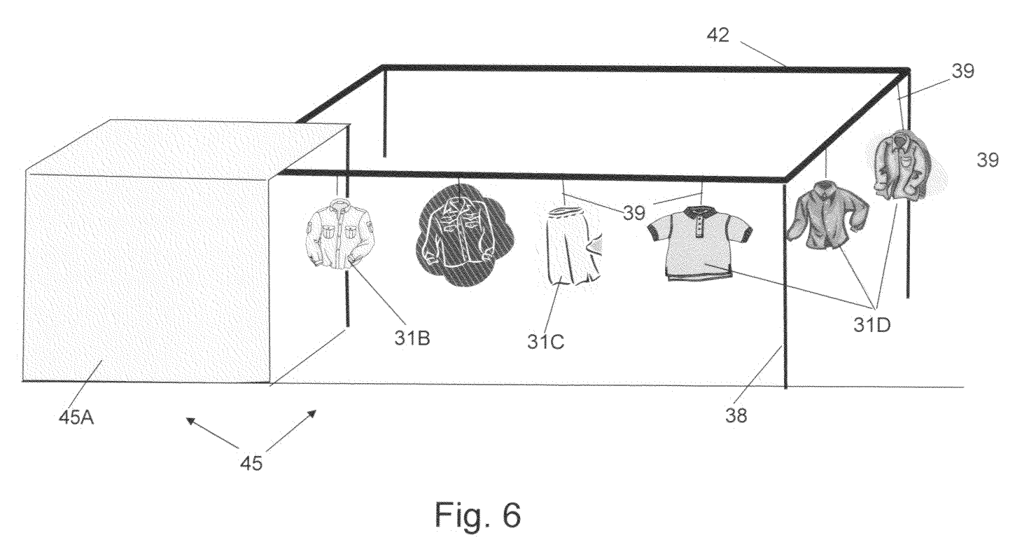

FIG. 6 is a drawing of a high volume shot blast process 45 to produce a high volume of the “Buck Shot Blues” special fabrics 30. Similar to the shotgun 37 and blast 41 system and the computer controlled blaster 44, this shot blast process 45 has a transfer means 42 to move the various garments 31B, 31C and 31D through the blast chamber 45A. The garments are hung by a means 39 from the transfer device 42. A support means 38 (floor or ceiling mounted) holds the whole system 45 securely, including the transfer means 42. One skilled in processes such as these appreciates that the shot blast chamber 45A is enclosed and permits a safe operation of the process.

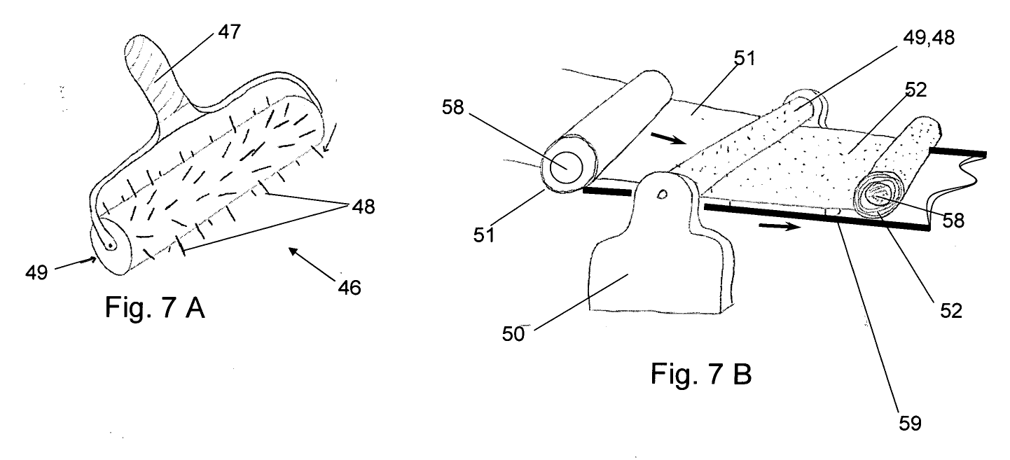

FIGS. 7A and 7B are sketches of alternative processes that utilize barbed spikes 48 on rollers 49 to mimic a blast and to produce low and high volumes of “Buck Shot Blues” special fabrics 30 and products. In FIG. 7A, a hand held roller 46 is shown. Here, a series of barbed spikes 48 are connected to a roller 49. The roller 49 is rotatably connected to a handle 47 by some means of connection. With this device 46, fabrics may be hand treated to provide the frayed apertures 32 in the fabric and mimic a blast system. In FIG. 7 B essentially the same concept is used to treat virgin fabric 51. Here a bolt of virgin fabric 51 on supports 58 is fed on a conveyor bed 59 of the piercing machine 50. The fabric 51 is penetrated by the barbed spikes 48 on the roller 49 as the fabric 51 passes under the roller 49. The resultant frayed apertures 32 are throughout the processed fabric 52. This processes fabric 52 is re-rolled onto a support 58. The process fabric 52 may then be used to make garments and other products with the “look” of the “Buck Shot Blues” special fabric 30.

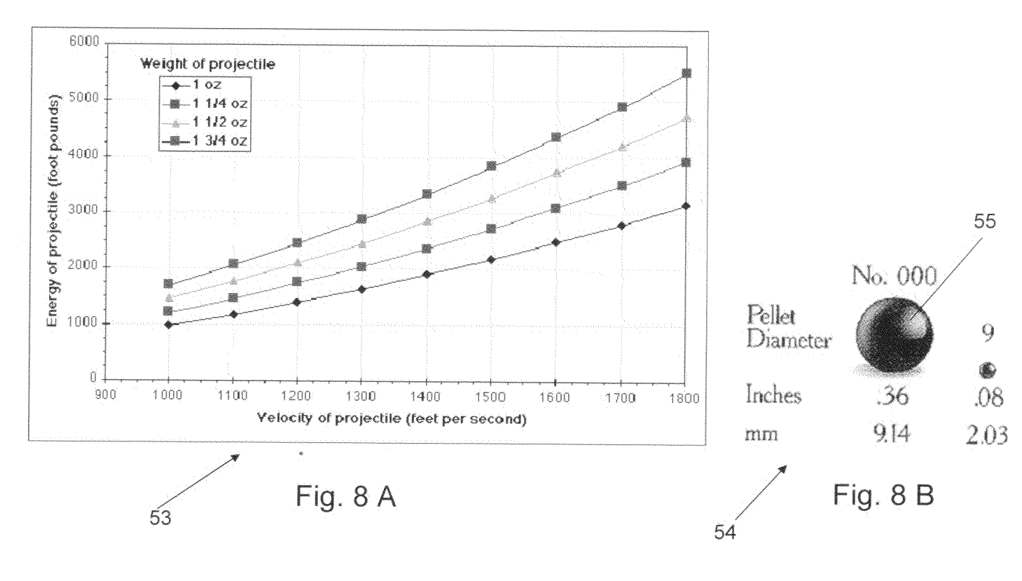

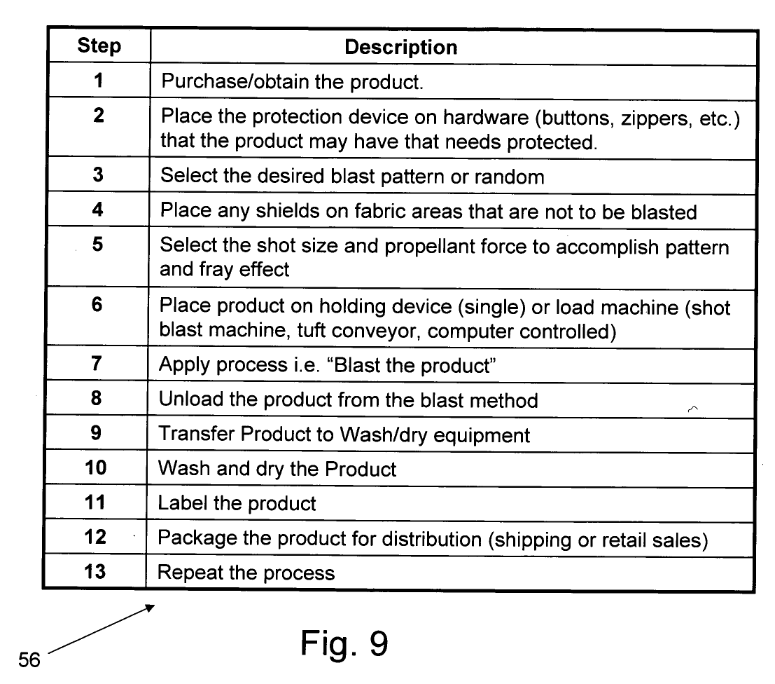

FIGS. 8A and 8B are charts showing typical blast velocities 53 and pellet details 54. While these are self explanatory, further understanding is served by referring to the above Table C for Blast details. FIG. 9 is a process flow chart 56 providing the basic and simple steps of the process to produce “Buck Shot Blues” special fabrics 30 and products. This process chart is described below in more detail in the Operation Section.

The details mentioned here are exemplary and not limiting. Other specific components and manners specific to describing a “Buck Shot Blues” special fabric and method 30 may be added as a person having ordinary skill in the field of special fabric alterations and methods to do the alteration well appreciates.

### Operation of the Preferred Embodiment

The new Special “Buck Shot Blues” special fabric and method 30 has been described in the above embodiment. The manner of how the device operates is described below. One notes well that the description above and the operation described here must be taken together to fully illustrate the concept of the Special “Buck Shot Blues” special fabric and method 30. The embodiment described above is essentially a fabric that has been processed and altered in a special way and the examples of methods to accomplish the special appearance that the fabric has been “blasted” by some form of buck shot or other appropriate media.

The condition of the “Buck Shot Blues” special fabric 30 having the frayed apertures 32 may be accomplished in many ways. One skilled in processes as described above appreciates the myriad of designs to machines to blast or to mimic a blast. As examples, and not limitations to the scope and sprit if this “Buck Shot Blues” creation, Table D describes some of these processes.

TABLE D
Alternative ways to apply “Blast Design”

| Method | Description |
|---|---|
| 1 | Single Shotgun blast |
| 2 | Shot blast machine with various types of blast media |
| 3 | Air/pellet guns with media blast |
| 4 | Computer controlled shot machine that picks product, |
| | blast pattern, blast media, then automatically |
| | completes process and transfers product to an exit |
| | position for automatic or manual unload and/or |
| | transfer to next step |
| 5 | Wire brush/tufting machine and conveyor — |
| | especially for processing large, continuous bolts of |
| | materials |
| 6 | Single wire roller (roller with rough spikes or |
| | equal means) for fraying single products |
| 7 | High pressure air, liquid, etc |

Returning to FIG. 4 which is a sketch showing a simple process to produce the “Buck Shot Blues” special fabrics 30 with a shotgun blast 41 or the like. When using shot blast 41, shot may contain many types and sizes of projectiles or pellets 55. For example, these types may be standard lead, steal shot, glass, plastics or the like. Reference to the description to FIG. 4 given above provide other operational details.

FIGS. 5A and B are sketches of a computer controlled process for manufacturing unique “Buck Shot Blues” special fabrics and products in a controlled yet flexible manner. This system may be used to process inputs from an internet sale. The ability to alter fabric on the computer controlled system 44 may be activated by outside persons on internet. A web site that allows the customer to indirectly modify their garments and products may accomplish control and choice in the cyber world. Each product chosen by the purchaser may be modified by the blast process. The system may be easily provided in a web friendly format in real time or delayed time.

FIG. 9 shows a process flow chart providing the basic and simple steps of the process to produce “Buck Shot Blues” special fabrics 30 and products. This process is shown in Table E.

TABLE E
PROCESS STEPS FOR BUCK SHOT BLUES PRODUCTS

| Step | Description |
|---|---|
| 1 | Purchase/obtain the product or fabric. |
| 2 | If needed, place the protection device on hardware |
| | (buttons, zippers, etc.) that the product may have |
| | that needs protected. |
| 3 | Select the desired blast configuration as patterned or |
| | random |
| 4 | Place any shields on fabric areas that are not to be |
| | blasted |
| 5 | Select the shot size and propellant force to |
| | accomplish pattern and fray effect |
| 6 | Place product on holding device (single) or load |
| | machine (shot blast machine, tuft conveyor, computer |
| | controlled) |
| 7 | Apply process i.e. “Blast the product” one or more |
| | times |
| 8 | Unload the product from the blast method |
| 9 | Transfer Product to Wash/dry equipment |
| 10 | Wash and dry the Product |
| 11 | Label the product |
| 12 | Package the product for distribution (shipping or |
| | retail sales) |
| 13 | Repeat the process |

Alterations and enhancements may be made to these process steps. For example, Alterations to the fabric may be made one at a time or multiples at a time. Patterns may be placed on product with precision or as a random effect. Some larger effects may be created by combining a series of smaller effects.

With this description it is to be understood that the Special “Buck Shot Blues” special fabric and method 30 is not to be limited to only the disclosed embodiment of product and processes. The features of the Special “Buck Shot Blues” special fabric and method 30 are intended to cover various modifications and equivalent arrangements included within the spirit and scope of the description.

What is claimed as new and desired to be protected by Letters Patent is:

1. A fabric object for use as a clothing garment with a unique and fashionable surface, comprising:
(a) a fabric panel and
(b) a plurality of frayed apertures throughout defined areas of the fabric whereby the fabric is use with various clothing products and fashion accessories and results in a new and unusual look for the product and accessories.

2. The object according to claim 1 wherein the fabric is a denim material.

3. The object according to claim 1 wherein the fabric is a cotton material.

4. The object according to claim 1 wherein the fabric is a hemp material.

5. The object according to claim 1 wherein the defined area is configured with the frayed apertures in a completely random result without a discernable pattern.

6. The object according to claim 1 wherein the defined area is configured with the frayed apertures as in a perceivable pattern.

7. The object according to claim 1 wherein the frayed apertures have a chemical treatment applied.

8. The object according to claim 7 wherein the chemical is a fabric dye.

9. The object according to claim 7 wherein the chemical is a bleaching substance.

10. A method for making a frayed fabric in a controlled manner comprising:
a) STEP 1: Purchase and obtain an object (a product or a fabric bolt).
b) STEP 2: Place a protection device on hardware (buttons, zippers, etc.) that the object may have that needs protected.
c) STEP 3: Select a desired blast configuration.
d) STEP 4: Place shields on fabric areas that are not to be blasted.
e) STEP 5: Select a shot size and propellant force to accomplish pattern and fray effect.
f) STEP 6: Place object on a holding device.
g) STEP 7: Apply a means to blast.
h) STEP 8: Unload the product from the blast method.
i) STEP 9: Transfer the Product to Wash and dry equipment.
j) STEP 10: Wash and dry the Product.
k) STEP 11: Label the product.
l) STEP 12: Package the object for distribution.
m) STEP 13: Repeat the process multiple times if required.

11. The method according to claim 10 wherein the object in STEP 1 is a bolt of fabric.

12. The method according to claim 10 wherein the object in STEP 1 is a product made of fabric.

13. The method according to claim 10 wherein the desired blast configuration in STEP 3 is a pattern.

14. The method according to claim 10 wherein the desired blast configuration in STEP 3 is random.

15. The method according to claim 10 wherein the holding device in STEP 6 is a single means to hold an object.

16. The method according to claim 10 wherein the holding device in STEP 6 is a transfer means capable of holding one or more objects and presenting the objects to the blast means.

17. The method according to claim 10 wherein the means to blast in STEP 7 is a shotgun.

18. The method according to claim 10 wherein the means to blast in STEP 7 is a shot blast machine with abrasive media.

19. The method according to claim 10 wherein the means to blast in STEP 7 is a computer controlled blast means that has an internet connection for data transfer whereby the means provides interactive communications with an operator from a remote location in order to select the object, material and blast pattern to be produced.

20. The method according to claim 10 wherein the means to blast in STEP 7 is a roller means with a plurality of stiff barbed wires protruding radially from the surface of the roller means.
